(19) United States
(12) Patent Application Publication
(10) Pub. No.: US 2007/0099041 A1
(43) Pub. Date: May 3, 2007

(54) Fuel cell with IC components

(76) Inventor: Chun-Chin Tung, Taipei (TW)

Correspondence Address: G. LINK CO. LTD., 3550 BELL ROAD, MINOOKA, IL, 60447, US

(21) Appl. No.: 11/263,900

(22) Filed: Nov. 2, 2005

(51) Int. Cl. H01M 8/04

(52) U.S. Cl. 429/22; 429/34; 429/26; 429/24

(57) ABSTRACT

The present invention relates to a fuel cell with IC component, having a substrate being a plate-like structure for constructing the fuel cell wherein a membrane electrode assembly, anode current collection circuitries, cathode current collection circuitries and an electrical wiring are set upon for performing an electro-chemical reaction that generates electrical power. More particularly, said electrical wiring includes one or more control mechanisms for corresponding to the operation of the fuel cell, and one or more IC components corresponding to the control mechanisms through which the control mechanisms are achieved by the logical operations of the IC components. The IC components are assembled by means of the conventional IC components bonding technology or connector technology in consideration of the required properties of the fuel cell.

### FIELD OF THE INVENTION

This invention relates to a fuel cell with IC components, particularly to a fuel cell integrated with IC components, wherein the IC components are assembled to the fuel cell by adopting an approach meeting the required operation environment of the fuel cell.

### BACKGROUND OF THE INVENTION

The conventional fuel cells use hydrogen containing fuel, such as methanol, to form a current circuitry after oxidization and reduction reaction, so as to generate electrical power. Such fuel cells require control of operation parameters, such as fuel supply and operation temperature during operation. Such operation parameters significantly affect the operation efficiency of the fuel cells, such that electrical wiring for obtaining control mechanisms of various operation parameters of the fuel cells is needed, while such electrical wiring must enable an easy integration with the fuel cell at the same time.

Furthermore, due to the existence of heat and corrosiveness in the operation environment under which the fuel cells are operated and the need of compact fuel cells, the formation of the electrical wiring in the fuel cells must be able to avoid increasing the size of the fuel cells and the electrical wiring must be adaptable to the operation environment of the fuel cells.

A fuel cell with IC components capable of overcoming the shortcomings of the conventional fuel cells is presented.

### SUMMARY OF INVENTION

A primary object of this invention is to provide a fuel cell integrated with IC components.

Another object of this invention is to provide a configuration of IC components on a fuel cell, which is able to adopt the operation environment of the fuel cell, like high temperature and corrosiveness, or to be miniaturized.

A further object of this invention is to provide a fuel cell integrated with IC components for obtaining operating means required for the operation of the fuel cell.

To achieve the above objects, this invention provides a fuel cell with IC components, having a substrate being a plate-like structure for constructing the fuel cell. On the substrate, a membrane electrode assembly, anode current collection circuitries, cathode current collection circuitries and an electrical wiring are set for performing electro-chemical reaction that generates electrical power. More particularly, the electrical wiring includes one or more control mechanisms adapted to the operation of the fuel cell, and one or more IC components corresponding to the control mechanisms wherein the control mechanisms are obtained by logical operations of the IC components, and the IC components are assembled by means of the conventional IC components bonding technology or connector technology in consideration of the required properties of the fuel cell.

### BRIEF DESCRIPTION OF THE DRAWINGS

These and other modifications and advantages will become even more apparent from the following description of the preferred embodiment of the invention and from the drawings in which:

FIG. 1 is a perspective view illustrating an embodiment of the fuel cell with IC components of this invention;

FIG. 2 is a perspective view of this invention at a viewing angle different from that of FIG. 1; and

FIG. 3 is a structural schematic view illustrating the invention fuel cell with IC components of this invention having a peripheral device.

### DETAILED DESCRIPTION OF THE INVENTION

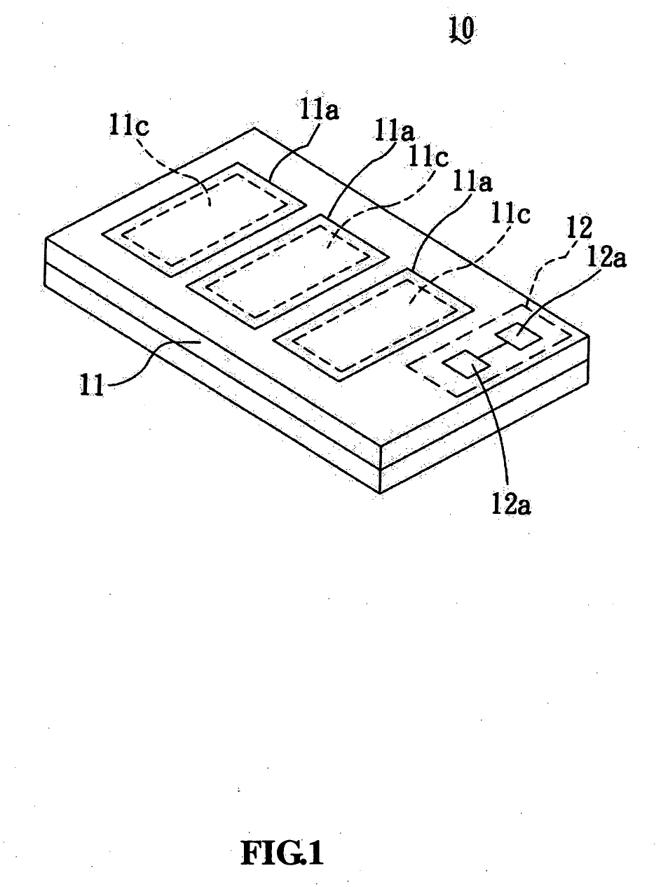

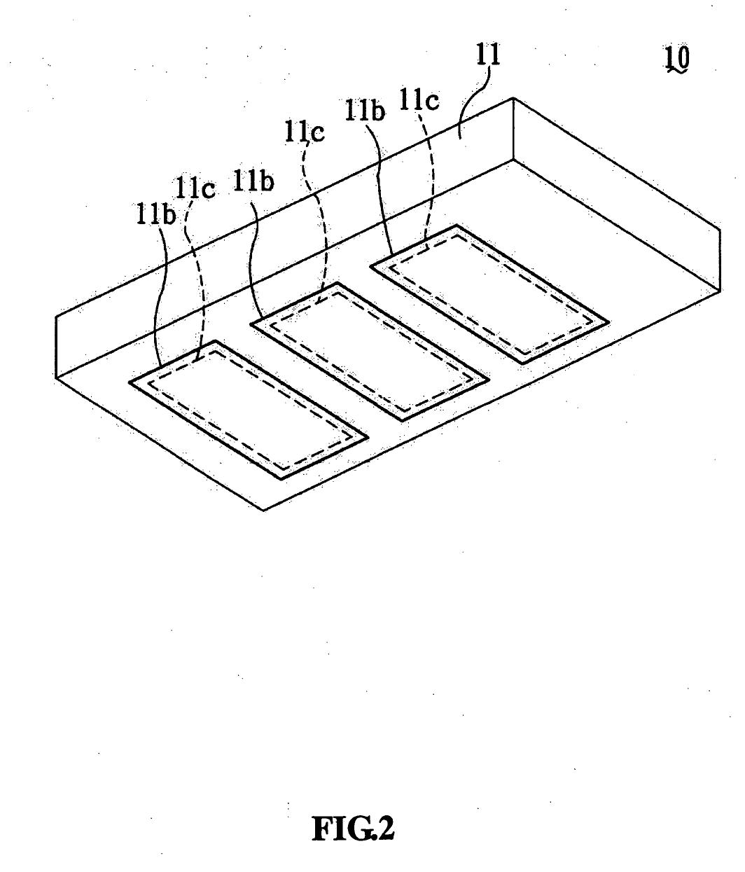

FIGS. 1 and 2 are perspective views of the fuel cell with IC components of this invention at different viewing angels. The fuel cell with IC components (10) of this invention includes a plate-like structure made by a printed circuit substrate (11) by which a membrane electrode assembly (11c), anode current collection circuitries (11a), cathode current collection circuitries (11b) and an electrical wiring (12) are set as described as follows.

In the fuel cell with IC components of this invention, the substrate (11) may be a single-layer or multi-layer FR4 substrate, an epoxy resin substrate, a glass fiber substrate, a ceramic substrate, a polymer plastic substrate or a composite material. The membrane electrode assembly (11c) is the core component for achieving the fuel cell electro-chemical reaction through which electrical power is generated and it can be a membrane electrode assembly using, for example, Nafion solution. The anode current collection circuitries (11a) and cathode current collection circuitries (11b) are conductive circuitries corresponding to the anode and cathode of power output of the membrane electrode assembly (11c), for outputting the electrical power. For example, the current collection circuitries may be formed on the substrate (11) through an etching process in the fabrication process of printed circuit boards. The electrical wiring (12) operates with the fuel cell (10) to perform electrochemical reaction, so as to obtain corresponding control mechanisms, wherein, the electrical wiring (12) further includes IC components (12a) serving to provide the abovementioned control mechanisms. For example, the control mechanisms corresponding to operation of the fuel cell may include load detection of the fuel cell, power output control and/or DC voltage regulation control of the fuel cell. In addition, the IC components (12a) are assembled by means of the conventional IC components bonding technology or connector technology in consideration of the desiring properties of the fuel cell. For example, the properties needed to be considered may include thermal resistant capability and/or heat dissipative capability and/or corrosion-resistant capability and/or ease-of-assembly and/or compactness. Thus, the IC components bonding technology as adopted may be surface mount technology (SMT), QFP series, PLCC, SOP series, DIP series, LOC series and gold-finger connector.

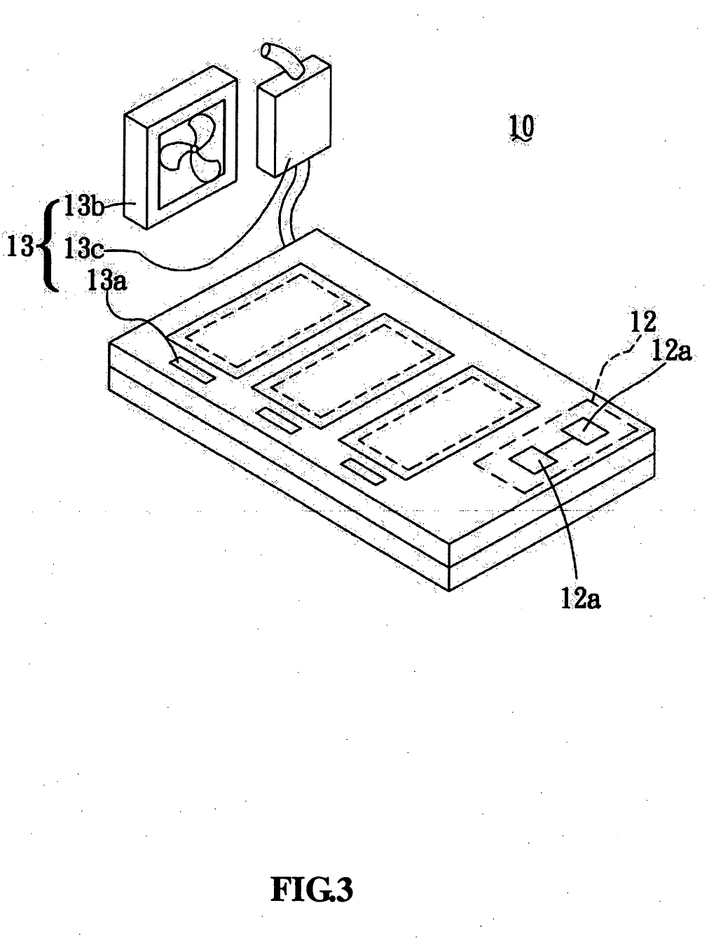

FIG. 3 is a structural schematic view illustrating the invention fuel cell with IC components of this invention having a peripheral device. The fuel cell with IC components of this invention may further includes a peripheral device (13) for detecting and/or controlling operation parameters of the fuel cell (10) so as to provide the control mechanisms corresponding to the IC components (12a). The operation parameters of the fuel cell (10) may include the temperature of the membrane electrode assembly, fuel concentration, flow rate of the fuel, electrical power wattage and/or current/voltage level. The peripheral device (13) may include one or more detecting components (13a) for detecting various physical properties of the fuel cell and the signals corresponding to the various physical properties detected by the detecting components (13a) may be transmitted to the IC components (12a) to serve as signals required by the logical operation of the control mechanisms

Furthermore, the peripheral device (13) may include a temperature regulating component (13b) and a concentration regulating component (13c), wherein the temperature regulating component (13b) may control the temperature accordingly through the control mechanisms of the IC components (12a). The temperature regulating component (13b) may, for example, be a fan. When the temperature of the membrane electrode assembly (11c) of the fuel cell (10) is detected by the detecting component (13a) and the temperature determined by the control mechanism of the IC components (12a) is exceeding a predetermined value, the control mechanism of the IC components (12a) would output a control signal to the temperature regulating component (13b) to control the fan operating under a corresponding power, so as to reduce the temperature of the membrane electrode assembly (11c) to the predetermined value. The concentration regulating component (13c) adjusts the fuel concentration correspondingly through the control mechanism of the IC components (12a). The concentration regulating component (13c) may, for example, be a pump. When the fuel concentration or fuel flow rate of the fuel cell (10) is detected by the detecting component (13a) and determined by the control mechanism of the IC components (12a) as lower than a predetermined value, the control mechanism of the IC components (12a) would output a control signal to the concentration regulating component (13c), making the pump operate under a corresponding power, so as to control the fuel concentration or fuel flow rate to reach the predetermined value.

While the abovementioned description is merely used to explain the preferred embodiment of the invention, it is not intended to limit the scope of the invention. Therefore, any change or modification under the spirit of the invention shall still be included in the scope of the invention.

What is claimed is:

1. A fuel cell with IC components, including a substrate being a plate-like structure for constructing the fuel cell and being provided thereon with a membrane electrode assembly, anode current collection circuitries, cathode current collection circuitries and an electrical wiring for performing electrochemical reaction that generates electrical power, characterized in that:
the electrical wiring is selectively includes:
one or more control mechanisms, adapted to operate the fuel cell; and
one or more IC components for obtaining the control mechanisms through logical operations.

2. The fuel cell with IC components of claim 1, wherein the IC components are assembled by means of the conventional IC components bonding technology and/or connector technology in consideration of the required properties of the fuel cell.

3. The fuel cell with IC components of claim 2, wherein the IC components are assembled by means of the conventional IC components bonding technology and/or connector technology in consideration of the required properties of the fuel cell including thermal resistant capability, heat dissipative capability, corrosion-resistant capability, ease-of-assembly and/or compactness.

4. The fuel cell with IC components of claim 3, wherein the IC components are assembled by the technology selected from: surface mount technology, QFP series technology, PLCC technology, SOP series technology, DIP series technology, LOC series technology and/or gold-finger connector technology.

5. The fuel cell with IC components of claim 4, wherein the control mechanisms of the IC components are selected from: load detection of the fuel cell, power output control and/or DC voltage regulation control of the fuel cell.

6. The fuel cell with IC components of claim 1, wherein the fuel cell further includes a peripheral device for detecting and/or controlling operation parameters of the fuel cell, so as to provide the control mechanisms corresponding to the IC components.

7. The fuel cell with IC components of claim 6, wherein the operation parameters of the fuel cell are selected from: membrane electrode assembly temperature, fuel concentration, fuel flow rate, electrical power wattage, current level and/or voltage level.

8. The fuel cell with IC components of claim 6, wherein the peripheral device selectively includes one or more detecting components for detecting various physical properties of the fuel cell, and signals detected by the detecting components corresponding to the various physical properties are transmitted to the IC components to serve as signals required by the logical operation of the control mechanisms of the IC components.

9. The fuel cell with IC components of claim 6, wherein the peripheral device selectively includes a temperature regulating component and concentration regulating component, wherein:
the temperature regulating component adjusts the temperature correspondingly through the control mechanisms of the IC components; and
the concentration regulating component adjusts the fuel concentration through the control mechanisms of the IC components.

10. The fuel cell with IC components of claim 9, wherein the temperature regulating component is a fan.

11. The fuel cell with IC components of claim 9, wherein the concentration regulating component is a pump.

12. The fuel cell with IC components of claim 1, wherein the substrate is selected from: a FR4 substrate, an epoxy resin substrate, a glass fiber substrate, a ceramic substrate, a polymer plastic substrate and/or composite material.

13. The fuel cell with IC components of claim 1, wherein the membrane electrode assembly is the core component for achieving the fuel cell electro-chemical reaction and performs the electro-chemical reaction to generate electrical power through a membrane electrode assembly achieved by Nafion solution.

14. The fuel cell with IC components of claim 1, wherein the anode current collection circuitries and cathode current collection circuitries are conductive circuitries corresponding to anode and cathode of power output of the membrane electrode assembly respectively for outputting the electrical power and the current collection circuitries are achieved by an application of fabrication process of printed circuit boards on the substrate.
